(19) United States
(12) Patent Application Publication
(10) Pub. No.: US 2021/0174454 A1
(43) Pub. Date: Jun. 10, 2021

(54) METHOD AND SYSTEM FOR NATURAL LANGUAGE PROCESSING FOR THE EVALUATION OF PATHOLOGICAL NEUROLOGICAL STATES

(71) Applicant: Robert Wooden, Rochester, NY (US)

(72) Inventor: Robert Wooden, Rochester, NY (US)

(21) Appl. No.: 17/113,096

(22) Filed: Dec. 6, 2020

Related U.S. Application Data
(60) Provisional application No. 62/944,367, filed on Dec. 6, 2019.

(51) Int. Cl. G06Q 40/08; G06K 9/62; G06F 16/2457

(52) U.S. Cl. CPC G06Q 40/08; G06F 16/24578; G06K 9/6215

(57) ABSTRACT

A method for generating an insurance quote, the method comprising: receiving a first set of data associated with a product from a first computing device and a second set of data associated with a customer from a second computing device, wherein the first and second computing devices have a set of unique data entry fields configured to receive data inputs from the customer and a third party; processing the first and second set of data, wherein the first and second set of data is manipulated to be received by a set of insurance carrier computers, wherein the first and second set of data is manipulated to be received by each of the independent insurance carrier computers; receiving a quote from each of the set of insurance carrier computers, wherein the quote is manipulated to create a distinct visual representation of each of the quotes; and presenting to the first computing device and the second computing device the distinct visual representations of the quotes.

### BACKGROUND

This disclosure relates generally commerce, and more specifically to a method, computer program and computer system for real-time insurance quotes for products.

Presently available on-line quoting tools for insurance products, such as auto insurance. However, the presently available quoting tools merely provide a wholesaler collecting the user's data and relaying this data to several different insurance companies who then individually contact the user with a specific rate or quote. Most users are looking for a quick easy and non-confrontational insurance quote.

The current environment consists, for example, of Hypertext Markup Language (HTML) forms that allow a user to enter some of the information needed for the generation of auto quotes. That information is then emailed to a customer support representative (CSR) via a Common Gateway Interface (CGI) process. The CSR subsequently contacts the user to gather additional information and generate a quote, for example, via a legacy system. Thus, it is not possible for the user to receive real-time advice, such as the availability of different types of insurance products or the various coverage requirements of different states.

Many dealers and companies (sellers) are able to complete the majority of the purchasing process but are not able to assist the user with the insurance aspect of the process. Due to this inability of the seller, they lose out on many potential sales because the user is unsure about the unknown cost of the insurance. If the user wants to get a quote for one insurance company, they need to input their information into the system manually and process it through. This may take time, may require personal information, or talking to a representative which many users do not have time for when they are out shopping.

Therefore, it is desired for a method, computer program, or computer system wherein the seller is able to immediately gather several different insurance quotes for the user with the information received from the user when collecting their general information.

### SUMMARY

In a first embodiment, the present invention is a method for generating an insurance quote, the method comprising: receiving a first set of data associated with a product and a second set of data associated with a customer; amending the first and second set of data, wherein the first and second set of data is manipulated; receiving a third set of data, wherein the third set of data is received from a plurality of insurance providers and is comprised of a set of insurance policies; and processing the third set of data to identify similarities and differences between the insurance policies; manipulating the third set of data based on a comparison between the third set of data and a fourth set of previously collected set of insurance policies; and presenting to a first computing device and a second computing device a distinct visual representations of the manipulated third set of data.

In a second embodiment, the present invention is a system for generating an insurance quote, the method comprising: a plurality of insurance carrier computers coupled with a web server through a telecommunication channel; a third-party computing device coupled with the web server through a telecommunication channel, comprising a data entry window comprising a plurality of data entry field configured to receive data inputs related to a product; a first computer interface displayed on a computer display coupled with the dealership computer, the first computer interface comprising a data entry window comprising a plurality of data entry fields configured to receive data inputs related to a customer, including: wherein a module is configured to, in response to an input from the dealership computer and the first computer interface, is prepare the inputs to be provided to the plurality of insurance carrier computers; and wherein the plurality of insurance carrier computers process the inputs and provide the module with a set of quotes, and the module prepares the set of quotes to be presented to the dealership computer and the first computer interface, comprising a quote viewing window configured to allow the customer and the dealership the set of quotes through the telecommunication channel.

In a third embodiment, the present invention is a method for generating an insurance quote, the method comprising: receiving a first set of data associated with a product from a first computing device and a second set of data associated with a customer from a second computing device; manipulating the first and second set of data, wherein the first and second set of data is manipulated to be received by a plurality of insurance companies; receiving a set of quote from each of the set of insurance companies; creating a first representation and a second representation of the set of quotes; and presenting to the first computing device and the second computing device the distinct visual representations of the quotes.

### BRIEF DESCRIPTION OF THE DRAWINGS

Referring now to the drawings in which like reference numbers represent corresponding parts throughout:

FIG. 1 depicts a cloud computing node according to an embodiment of the present invention.

FIG. 2 depicts abstraction model layers according to an embodiment of the present invention.

FIG. 3 depicts a block diagram depicting a computing environment according to an embodiment of the present invention.

FIG. 4 depicts a flowchart of the operational steps taken by a program within the computing environment of FIG. 1 according to an embodiment of the present invention.

FIG. 5 depicts a block diagram depicting a computing environment according to another embodiment of the present invention.

FIG. 6 depicts an exemplary device screen capture showing a user interface, in according to an embodiment of the present invention.

FIG. 7 depicts an exemplary device screen capture showing a user interface, in according to an embodiment of the present invention.

### DETAILED DESCRIPTION

The present invention provides the benefit of using readily available customer data extracted from a system to automatically generate an estimated insurance quote and displays the quote at the point of sale.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the flowchart illustrations, and combinations of blocks in the flowchart illustrations, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

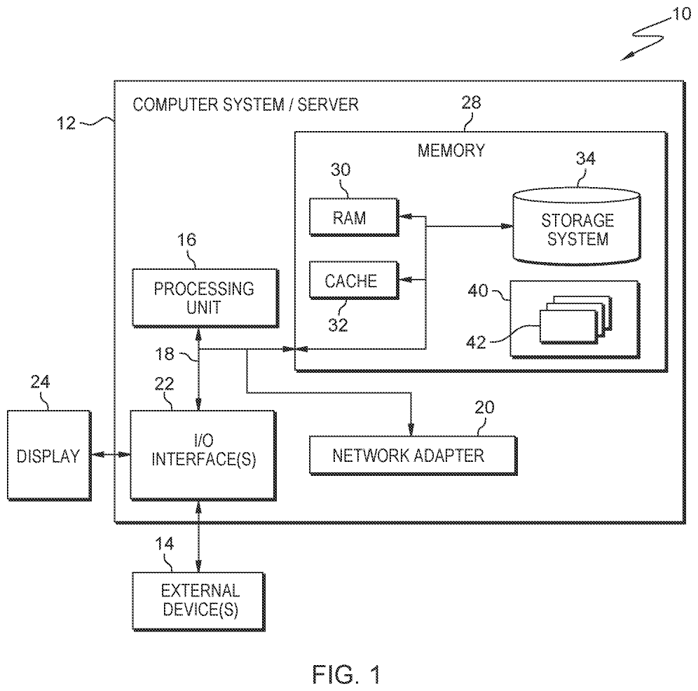

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purposes or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

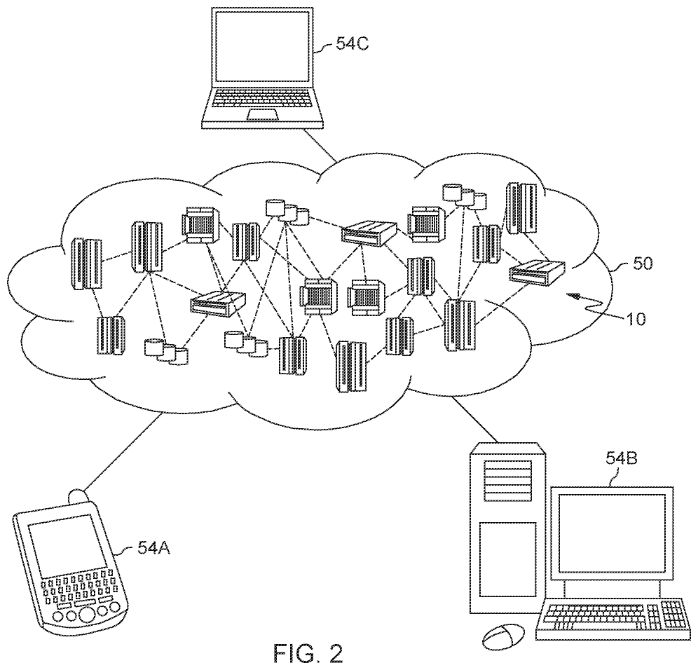

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, and laptop computer 54C may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-C shown in FIG. 2 are intended to be illustrative only and that computing nodes 10 and cloud computing environment 50 can communicate with any type of computerized device over any type of network and/or network addressable connection (e.g., using a web browser).

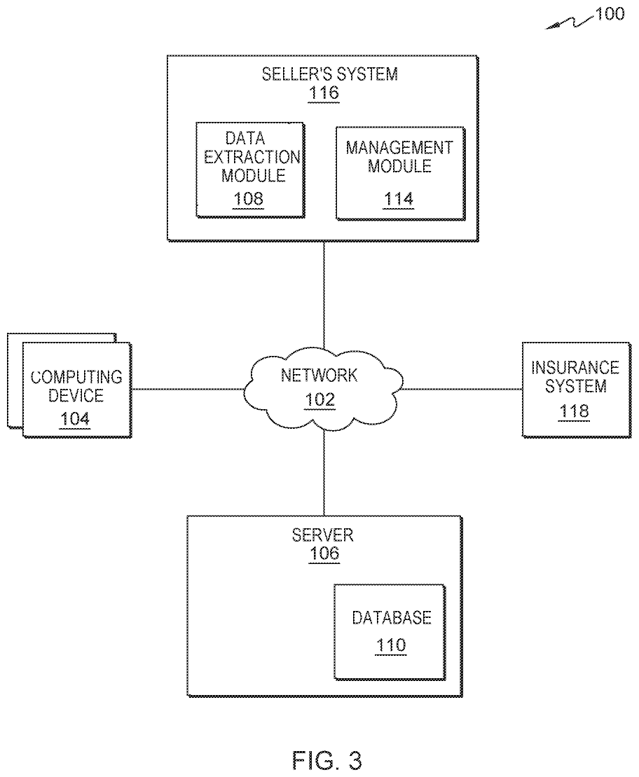

FIG. 3 depicts a block diagram of a computing environment 100 in accordance with one embodiment of the present invention. FIG. 1 provides an illustration of one embodiment and does not imply any limitations regarding the environment in which different embodiments maybe implemented.

In the depicted embodiment, computing environment 100 includes network 102, computing device 104, server 106, insurance system 118, and seller's system 116. Computing environment 100 may include additional servers, computers, or other devices not shown.

Network 102 may be a local area network (LAN), a wide area network (WAN) such as the Internet, any combination thereof, or any combination of connections and protocols that can support communications between computing device 104 and server 106 in accordance with embodiments of the invention. Network 102 may include wired, wireless, or fiber optic connections.

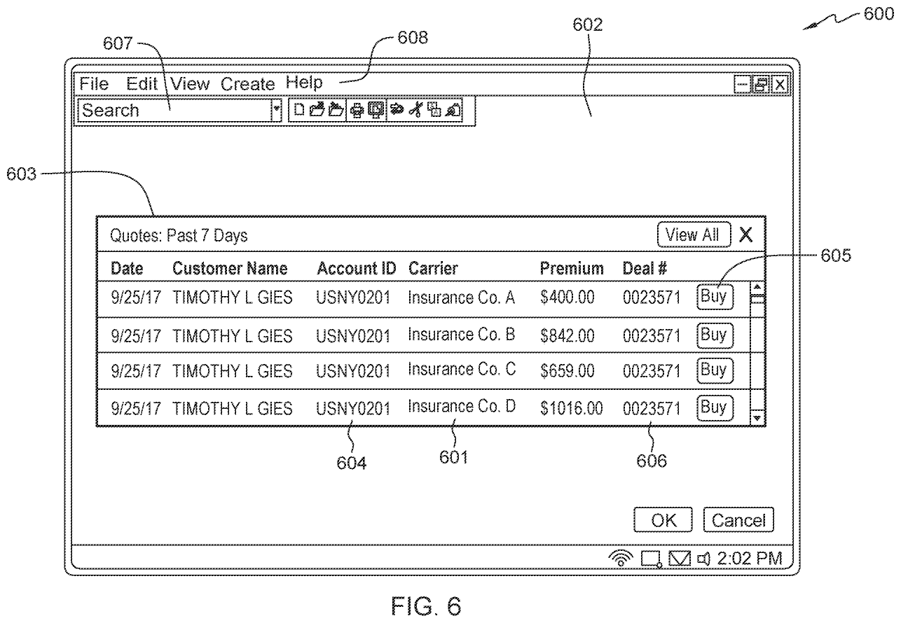

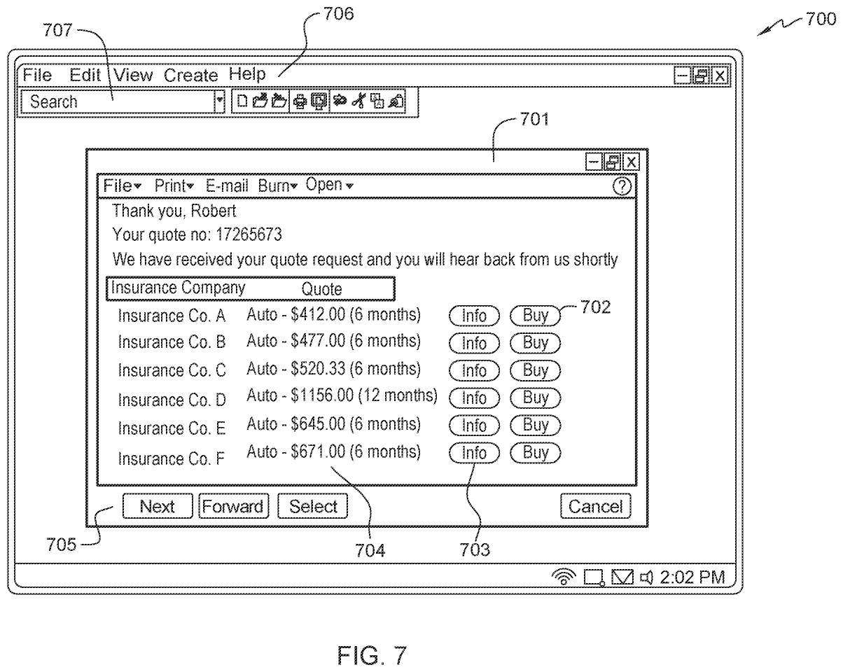

Computing device 104 is the device used by the employee or the customer at the seller and is related to FIGS. 6 and 7. In some embodiments, computing device 104 may be a management server, a web server, or any other electronic device or computing system capable of processing program instructions and receiving and sending data. In some embodiments, computing device 104 may be a laptop computer, tablet computer, netbook computer, personal computer (PC), a desktop computer, or any programmable electronic device capable of communicating with server 106 via network 102. In other embodiments, computing device 104 may represent a server computing system utilizing multiple computers as a server system, such as in a cloud computing environment. In another embodiment, computing device 104 represents a computing system utilizing clustered computers and components to act as a single pool of seamless resources. In the depicted embodiment, computing device 104 includes Data extraction module 108, and database 110. In other embodiments, computing device 104 may include any combination of Data extraction module 108 and database 110. computing device 104 may include components, as depicted and described in further detail with respect to FIG. 1.

Computing Device 104 may be of the customer or the seller/dealer employee. In the depicted embodiment, the computing devices 104 are connected to the network 102 and are able to communicate with the seller's system 116 and the server 106. In some embodiments, where computing device 104 is an employee computing device, the computing device includes modules 108 and 114, and database 110.

Server 106 may be a management server, a web server, or any other electronic device or computing system capable of processing program instructions and receiving and sending data. In other embodiments server 106 may be a laptop computer, tablet computer, netbook computer, personal computer (PC), a desktop computer, or any programmable electronic device capable of communicating via network 102. In one embodiment, server 106 may be a server computing system utilizing multiple computers as a server system, such as in a cloud computing environment. In one embodiment, server 106 represents a computing system utilizing clustered computers and components to act as a single pool of seamless resources. In the depicted embodiment database 110 is located on server 106. Server 106 may include components, as depicted and described in further detail with respect to FIG. 1.

Data extraction module 108 operates to locate/receive, organize, collect, and submit the customer information, and the relevant information about the product or service and communicates with the management module 114 and the insurance system 118 and database 110 to process, generate, manipulate, amend, or alter the insurance policy quote. In the depicted embodiment, Data extraction module 108 operates to perform the processing of the customer information, the generation of the insurance quotes, and the presentation of the insurance quotes to the retailer and the customer. Data extraction module 108 operates to relay the information from the insurance system to the seller's system. In some embodiments, the Data extraction module 108 provides updated or correct data to the data extraction system. The Data extraction module 108 is able to decrypt and modify the information about the quotes to be provided to the employee computing device and the customer computing device in a comprehendible format. The Data extraction module 108 is able to communicate with the management module 114, the database 110, and the insurance system 118 to extract and transmit the data to the correct recipient. The management module 114 is connected with the Data extraction module 108 to send and receive the data. In some embodiments, the Data extraction module 108 communicates with the management module 114. In some embodiments, the data sent and received from the Data extraction module 108 is encrypted to protect personal information or data. In the depicted embodiment, Data extraction module 108 utilizes network 102 to access the server 106, computing device 104, and the insurance system 118. In one embodiment, Data extraction module 108 resides on seller's system 116. In other embodiments, Data extraction module 108 may be located on another server or computing device, provided Data extraction module 108 has access to access the server 106, computing device 104, and the insurance system 118.

Database 110 may be a repository that may be written to and/or read by Data extraction module 108. Such information may include product information, customer information, insurance provider information, previous quotes, policy terms and the like. In one embodiment, database 110 is a database management system (DBMS) used to allow the definition, creation, querying, update, and administration of a database(s). In the depicted embodiment, database 110 resides on computing device 104. In other embodiments, database 110 resides on another server, or another computing device, provided that database 110 is accessible to Data extraction module 108.

Seller's system 116 may be a management server, a web server, or any other electronic device or computing system capable of processing program instructions and receiving and sending data. In other embodiments seller's system 116 may be a laptop computer, tablet computer, netbook computer, personal computer (PC), a desktop computer, or any programmable electronic device capable of communicating via dealer network. In one embodiment, seller's system 116 may be a server computing system utilizing multiple computers as a server system, such as in a cloud computing environment. In one embodiment, seller's system 116 represents a computing system utilizing clustered computers and components to act as a single pool of seamless resources.

Management Module 114 operates to perform an analysis on the buyer's inputs to assist in generating an accurate quote. In the depicted embodiment, Management Module 114 utilizes the seller's system 116 to access the employee computing device 112 and to access network 102. In one embodiment, Management Module 114 resides on the seller's system 116. In other embodiments, Management module 114 may be located on another server or computing device, provided Management Module 114 has access to database 110. In some embodiments, the data sent and received from the Management Module 114 is encrypted to protect personal information or data. In the depicted embodiment, Management Module 114 utilizes network 102 to access the server 106, computing device 104, and the insurance system 118. In one embodiment, Management Module 114 resides on seller's system 116. In other embodiments, Management Module 114 may be located on another server or computing device, provided Management Module 114 has access to access the server 106, computing device 104, and the insurance system 118.

Insurance System 118 is the internal system of the various insurance companies, carriers, or third parties which process and provide the insurance quotes for the customer and dealership employee. The Insurance system 118 may be a management server, a web server, or any other electronic device or computing system capable of processing program instructions and receiving and sending data. In one embodiment, Insurance system 118 represents a computing system utilizing clustered computers and components to act as a single pool of seamless resources.

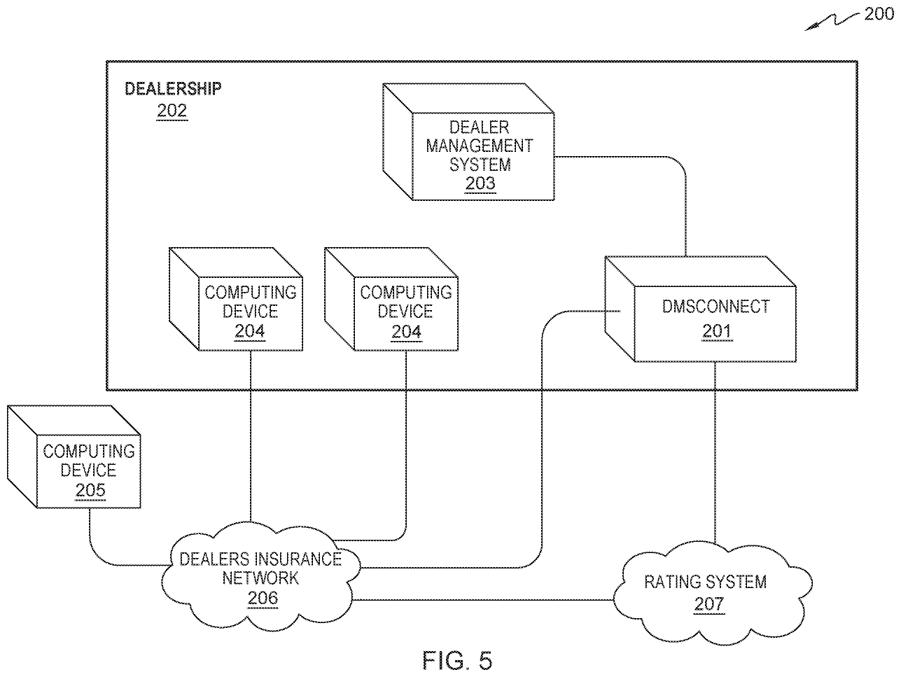

FIG. 5 depicts a block diagram 200 for a computing network, in accordance with another embodiment of the present invention related specifically to vehicle dealerships. The depicted diagram an internal system within a dealership.

Dealership Insurance Network 206 may be a local area network (LAN), a wide area network (WAN) such as the Internet, any combination thereof, or any combination of connections and protocols that can support communications between computing device 205, the dealership 202 and the rating system 207 in accordance with embodiments of the invention. Network 206 may include wired, wireless, or fiber optic connections.

The Computing devices 204 and 205 are the customer and dealership employee computing devices respectively and may be a management server, a web server, or any other electronic device or computing system capable of processing program instructions and receiving and sending data. In the depicted embodiment computing device 205 is a customer device and the computing devices 204 are the employee devices. In some embodiments, the computing devices may be a laptop computer, tablet computer, netbook computer, personal computer (PC), a desktop computer, or any programmable electronic device capable of communicating with the rating system 207 via network. In other embodiments, the computing devices may represent a server computing system utilizing multiple computers as a server system, such as in a cloud computing environment. In another embodiment, the computing devices represents a computing system utilizing clustered computers and components to act as a single pool of seamless resources. the computing devices may be accessible to the customer and the employee of the dealership, or one or the other and is used to collect the information from the customer necessary to generate the quote. the computing devices may include components, as depicted and described in further detail with respect to FIG. 1. In the depicted embodiment, the computing devices 204 are within the dealership, this may be literally in that the customer needs to come into the dealership to connect to the dealer's insurance network 206. In some embodiments, the customer will be able to access the network remotely and be able to provide this information to the dealership.

Dealership 202 identifies the vehicle dealership and the components of the dealership 202 which are within their system. The computing devices 204, the Dealer Management System 203 and the DMSConnect 201 are able to communicate within the dealership 202 and are able to connect to the network 206 to communicate with the respective components.

Dealer Management System 203 operates to collect and store the vehicle data, the dealership data, and the customer data. Dealership Management System 203. The Dealer Management System 203 stores and collects the information related to the vehicle. DMSConnect 201 processes the information from the Dealer Management system 203 and manipulates the date to provide to the rating system 207 or to prepare data to be sent to the Dealer Management system 203. DMSConnect 201 may also manually generate quotes or modify quotes which are received by the rating system 207. The DMSConnect 201 is able to manipulate or amend the data which was supplied related to the vehicle and the customer based on the rating system 207 requirements. DMSConnect 201 is able to access the insurance providers to collect various information related to the quotes (e.g. policy terms) and use this data to amend or alter the information which is presented to the customer and the employee. In many instances the customer supplied data, the Dealership supplied data are not formatted or organized for the rating system 207 to process, or need to be provided to the rating system 207 in different formats based on the insurance company. In some instances, one insurance company may require more information than others and this information is selected and presented to that one insurance company. The DMSConnect 201 operates to locate/receive, organize, collect, and submit the customer information, and the relevant information about the product or service and communicates with the rating system 207 to process the insurance quote request.

The rating system 207 operates to perform the processing of the customer information and the vehicle information and generate the insurance quotes for the customer from one or more insurance company. This rating system 207 may be directly connected to various insurance companies to be able to receive the generated quotes. In other instances, the rating system 207 is able to generate an estimate quote for the customer based on previously collected and known data and the information supplied related to the customer and the vehicle. Through the use of the previously generated quotes and knowledge of the insurance company's calculations, the rating system 207 is able to generate a quote that is quick and accurate based on the vehicle and the customer.

The present embodiment allows for a direct connection between the rating system 207 and the dealership 202 so that the collection of the data from the customer and the dealership can be easily compiled, altered, manipulated, and send to the rating system 207 for a quick and accurate generation of the quote to be sent the computing devices 204 and 205.

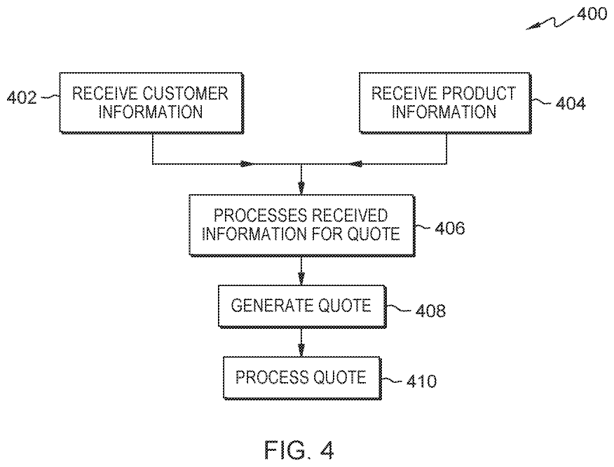

FIG. 4 shows flowchart 400 depicting a method according to the present invention. The method(s) and associated process(es) are now discussed, over the course of the following paragraphs, with extensive reference to FIG. 3, in accordance with one embodiment of the present invention.

The program(s) described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

In steps 402 and 404, the data extraction module 108 receives the customer information 402 and the product information 404. This information associated with the customer is related is based on the information which would be required by an insurance company based on the product. The information associated with the product typically manufacturer related information which would be needed by an insurance company. This may be product numbers, SKU numbers, VIN numbers, or the like based on the specific product, the product type, and the insurance company requirements. Additionally, the customer information may be provided directly by the customer or collected from a third party who has access to or has the customer information which is necessary to generate the quote. Data extraction module 108 may request specific information from the management module 114 and the insurance system 118. In some embodiments, database 110 stores the required customer and product information required based on collected data. Steps 402 and 404 may happen simultaneously or in series based on the availability of the information and the delay or absence of required information. In some embodiments, the information may be received from an image of the customer's drivers license, an image of the automobiles VIN number, or an image of the product. With the image, additional information, such as information related to the location of the customer or the product, which is then collected.

In step 406, the data extraction module 108 processes the received information related to the customer and the product to generate a quote. The quote is the cost to insure the product based on the product information and the customer information. Typically, insurance quotes are dynamic based on the customer information and the product information. For example, insurance on an automobile may be based on the customers age, sex, location, driving history, and vehicle specifications. The quote may be generated internally based on known data stored in database 110 or may submit the information to a third-party system to generate the quote. The received information may be organized, re-structured, encrypted, or modified based on the requirements or restrictions of the module, computing devices, or management module 114. The quote may be generated from the plurality of insurance companies based on standard time frames, features, aspects, limitations, deductibles, coverages, and the like. As module 108 may also create multiple quotes from a single insurance company based on the different types of insurance policies available to the customer.

In step 408, the data extraction module 108 and the management module 114 generate the quote for the customer based on the collected information. The generation of the quote may be through providing the collected information to the insurance system 118 for the insurance system 118 to generate a quote internally, or the extraction module 108 and the management module 114 generate a quote based on the collected information. The quote may either be an exact price required for the insurance provider or may be an estimate based on the collected information. In some industries, insurance policies may require additional information which is not accessible at the time (due to the data being maintained by a third party) so an estimate is the only available option for the customer.

Based on the collected customer and product information, the management module 114 is able to access the insurance providers through the insurance system 118 and generate a variety of quotes for the customer based on available insurance policies each provider offers. In some embodiments, the modules are able to generate quotes of similar policy limits and terms. These quotes are then analyzed and sorted based on the policy requirements, restrictions, limits, and terms based on the collected information. The modules may sort out policies which are outside of limitations set by the customer, the seller, or which quotes which are unrealistic based on the extraction module 108 and the management modules 114 assessment.

The generated quote for insurance coverage for the product to be insured. In various embodiments, the quote may be for a recommended and/or requested amount of insurance coverage for the product to be insured. In various embodiments, at least some of the received information/data and/or information/data determined by analyzing/processing image information/data associated with the property to be insured may be used to generate the quote. In various embodiments in which customer information/data, contact information/data, and/or identifying information/data is received, at least some of the customer information/data, contact information/data, and/or identifying information/data may be used to generate the quote. In various embodiments, the quote may be provided without being underwritten in order to provide the customer with an instant quote or provisional quote. In such embodiments, a neutral credit score may be assumed rather than generating, requesting, or otherwise accessing an insurance score or credit information associated with the customer. In various embodiments, a bindable quote may be provided. The bindable quote may be provided in real-time or near real-time in various embodiments.

In embodiments in which a quote is provided, an insurance score associated with the user may be generated, requested, and/or accessed. For example, at least some of the received user information/data, contact information/data, and/or identifying information/data may be used to generate an insurance score for the user. In various embodiments, the received user information/data, contact information/data, and/or identifying information/data may comprise various information/data associated with the property owner.

In other embodiments, an insurance score associated with the user may be requested from a credit reporting agency and/or another source. For example, in an embodiment in which the quote is not underwritten and/or an insurance score is not generated or received, the quote may be a provisional quote. For example, a neutral credit score may be assumed rather than calculating, requesting, or otherwise accessing credit information associated with the user. Thus, a provisional quote may be provided as an instant quote for insuring the property that may be further evaluated and/or underwritten later.

The quote may also be calculated based on an analysis of previously generated quote to customers with like or similar information. Through an analysis of the customer and comparing their information to other previously issued quotes, the program may generate a non-binding quote to give a fast and reliable estimate to what insurance may cost. This is beneficial in situations where a customer does not want a hard check on their credit or the like.

In step 410, the modules processes the quotes and provides the quotes to the customer and the seller to allow the seller and the customer to review the quotes and determine which policy for the customer to purchase and to proceed with the purchasing of the insurance policy. The processing of the quote may require the alteration of the data to a predetermined layout or design so as to be easily read and understood by the customer and the seller. Based on the systems which are being used by the seller and the customer, the quote may be provided in different in independent formats directed towards each party and the information which is most relevant to each party. This may include the use of images or the like to highlight key features of each quote. In some embodiments where multiple quotes are provided, these quotes may be presented in a way to compare the quotes and highlight the differences between the quotes. In some embodiment, the module 108 is able The processing of the quotes may include the manipulation of quotes which are outside the limitations, unrealistic (based on an analysis and comparison of the other quotes), quotes with errors, or quotes which are incomplete. The processing may also include the arranging of the quotes based on various terms or characteristics of the quotes.

The processing of the quote may provide the generated quote. FIGS. 6 and 7 illustrates examples of the quotes view of the user interface displaying a quote generated and provided by the system. The quote view may include location information/data and/or other information/data associated with the property to be insured. The quote view may include a quote summary. For example, the quote summary may summarize the cost per month and/or per year and/or the like for the quoted insurance coverage. The quote summary may include other information/data summarizing the provided quote. The quote view may also provide further information/data related to the provided quote. For example, the quote view may include standard coverages that may include information/data regarding the coverages and/or the like associated with the provided quote. In various embodiments, the quote view may include policy deductibles associated with the generated and provided quote.

FIG. 6 is an image of a user interface 600 for a dealership employee. After the quote is generated, the employee is presented with a window 603 on their computing device screen 602 which shows the various quotes for the present (and past) customer. Each customer is provided an account ID 604 to assist the employee in identifying which quotes are related to the customer. Each quote is separated by the insurance provider 601. Each quote is associated with a deal 606, which is used to assist the dealership in separating out the quotes to specific customers or based on specific factors or aspects to be used internally. Each quote has a purchase or buy icon 605 to allow the employee to process through for the customer the purchasing process of the quote and connect with the specific carrier. The user interface includes various drop-down menus 608 and search bars 607 to sort through the quotes based on a variety of factors or search terms. The account ID 604 and the Deal #606 may be generated internally by the dealership or may be generated by the present invention when the quotes are generated. This may also apply when the quotes are generated based on previously collected data instead of direct communication with each insurance carrier.

In FIG. 7, an image of the user interface 700 shows how the quote is presented to the customer. The customer is presented on their computing device the window 701 which shows all the quotes received from the various insurance companies 704. This may include the type of vehicle (e.g. auto stands or automobile), the cost (per pay period). The user is also presented with an info icon 703 to access more information about the quote, which shows specifics and detailed breakdowns of the policy. The user also has the access to directly purchase an insurance policy through icon 702. Depending on the number of quotes generated, the window 701 may have various icons 705 to scroll through the quotes, or the ability to select multiple quotes to compare the selected quotes. The quotes are shown by varying prices, time frames, company, and the like to give the customer a clear description of each quote. The customer may be able to access additional information about the quotes for various links, or menus which are included within the user interface. The customer also has the option to purchase the quote. In this step the customer is in direct contact with the insurance company to provide additional information and complete the process of purchasing the policy. The user interface includes various drop-down menus 706 and search bars 707 to sort through the quotes based on a variety of factors or search terms.

In some embodiments, the quote may include deductibles viewable in a drop-down menu and/or other mechanisms for a user to select and/or otherwise enter an updated value for a particular coverage and/or deductible. In some such embodiments, after receiving input indicating user selection or change of a particular coverage and/or deductible, or perhaps in response thereto, the quote system may automatically generate and provide an updated quote.

In various embodiments, the customer may request a formal quote by a specific insurance provider by selecting the save quote button/icon/input/graphic or (b) to initiate the buying of the insurance policy associated with the provided quote by selecting the buy now button/icon/input/graphic. After receiving input indicating user selection of the buy now button/icon/input/graphic, or perhaps in response thereto, the quote system may provide the user with a user interface to guide the user through the process of purchasing the insurance policy associated with the provided quote.

In various embodiments, various credits, discounts, and/or similar words used herein interchangeably may be available based, at least in part, on aspects associated with the product and the customer information. For example, if an automobile has various safety features which are able to reduce the insurance rates, the automobile may qualify for a reduction in the insurance rate, or if the driver has a clean driver history, they may qualify for deductions which are not available when performing a quick generation of insurance quotes. The system may be able to access the list of deductions associated with various products, so that questions related to these deductions are presented to the customers. In some embodiments, when a pictures of the automobile is taken, the system is able to analyze the pictures to determine a automobile type (car, truck, SUV, etc.), damage, or features to adjust the quotes. In some embodiments, the program may receive reports or reviews of the product to adjust the quote. For example, a report of the car showing the front, sides, and rear and any damage or features. In some embodiments, the program applies a confidence score to the quote based on the information received and the known information which is necessary to generate a quote to assist the customer or the party with using the accuracy of the quote.

The module 108 may take the quotes generated from the insurance system 118 and manipulate the data to provide to the dealership and the customer to varying visual representations of the information which was collected. This may include the removal, repositioning, adjustment, or manipulation of the data to present each party which information which is relevant and necessary as well as provide each party which the necessary options and information to assist in the insurance selection process.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

The foregoing descriptions of various embodiments have been presented only for purposes of illustration and description. They are not intended to be exhaustive or to limit the present invention to the forms disclosed. Accordingly, many modifications and variations of the present invention are possible in light of the above teachings will be apparent to practitioners skilled in the art. Additionally, the above disclosure is not intended to limit the present invention. In the specification and claims the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g. attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between network connections of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements and/or substantial equivalents.

What is claimed is:

1. A method for generating an insurance quote, the method comprising:
receiving a first set of data associated with a product and a second set of data associated with a customer;
amending the first and second set of data, wherein the first and second set of data is manipulated;
receiving a third set of data, wherein the third set of data is received from a plurality of insurance providers and is comprised of a set of insurance policies; and
processing the third set of data to identify similarities and differences between the insurance policies;
manipulating the third set of data based on a comparison between the third set of data and a fourth set of previously collected set of insurance policies; and
presenting to a first computing device and a second computing device a distinct visual representations of the manipulated third set of data.

2. The method for generating an insurance quote of claim 1, further comprising: manipulating the first computing device interface and the second computing device interface based on the quotes.

3. The method for generating an insurance quote of claim 1, further comprising: providing a series of data options to the first and second computing devices to adjust the set of quotes provided.

4. The method for generating an insurance quote of claim 1, further comprising: requesting at least one image associated with the customer and at least one image associated with the product, wherein the images are analyzed to extract predetermined data to be populated into the data entry fields.

5. The method for generating an insurance quote of claim 1, wherein the set of quotes are organized based on a predetermined order.

6. The method for generating an insurance quote of claim 1, further comprising: calculating a confidence score related to each of the set of quotes and applying the confidence score to each of the set of quotes when organizing the set of quotes.

7. A system for generating an insurance quote, the method comprising:
a plurality of insurance carrier computers coupled with a web server through a telecommunication channel;
a third-party computing device coupled with the web server through a telecommunication channel, comprising a data entry window comprising a plurality of data entry field configured to receive data inputs related to a product;
a first computer interface displayed on a computer display coupled with the dealership computer, the first computer interface comprising a data entry window comprising a plurality of data entry fields configured to receive data inputs related to a customer, including:
wherein a module is configured to, in response to an input from the dealership computer and the first computer interface, is prepare the inputs to be provided to the plurality of insurance carrier computers; and
wherein the plurality of insurance carrier computers process the inputs and provide the module with a set of quotes, and the module prepares the set of quotes to be presented to the dealership computer and the first computer interface, comprising a quote viewing window configured to allow the customer and the dealership the set of quotes through the telecommunication channel.

8. The system for generating an insurance quote of claim 7, further comprising: manipulating the first computing device interface and the second computing device interface based on the quotes.

9. The system for generating an insurance quote of claim 7, further comprising: providing a series of data options to the first and second computing devices to adjust the set of quotes provided.

10. The system for generating an insurance quote of claim 7, further comprising: requesting at least one image associated with the customer and at least one image associated with the product, wherein the images are analyzed to extract predetermined data to be populated into the data entry fields.

11. The system for generating an insurance quote of claim 7, wherein the set of quotes are organized based on a predetermined order.

12. The system for generating an insurance quote of claim 7, further comprising: calculating a confidence score related to each of the set of quotes and applying the confidence score to each of the set of quotes when organizing the set of quotes.

13. The system for generating an insurance quote of claim 7, further comprising, compiling a set of policy terms related to each of the set of quotes.

14. The system for generating an insurance quote of claim 7, further comprising, generating at least one quote based on the data input and a set of previously collected quotes, wherein the set of previously collected quotes are selected based on the data input.

15. A method for generating an insurance quote, the method comprising:
receiving a first set of data associated with a product from a first computing device and a second set of data associated with a customer from a second computing device;
manipulating the first and second set of data, wherein the first and second set of data is manipulated to be received by a plurality of insurance companies;
receiving a set of quotes from each of the set of insurance companies;
creating a first representation and a second representation of the set of quotes; and
presenting to the first computing device and the second computing device the distinct visual representations of the quotes.

16. The method for generating an insurance quote of claim 13, further comprising: manipulating the first computing device interface and the second computing device interface based on the quotes.

17. The method for generating an insurance quote of claim 13, further comprising: providing a series of data options to the first and second computing devices to adjust the set of quotes provided.

18. The method for generating an insurance quote of claim 13, further comprising: requesting at least one image associated with the customer and at least one image associated with the product, wherein the images are analyzed to extract predetermined data to be populated into the data entry fields.

19. The method for generating an insurance quote of claim 13, wherein the set of quotes are organized based on a predetermined order.

20. The method for generating an insurance quote of claim 3, further comprising: calculating a confidence score related to each of the set of quotes and applying the confidence score to each of the set of quotes when organizing the set of quotes.
